(19) United States
(12) Patent Application Publication
(10) Pub. No.: US 2024/0286397 A1
(43) Pub. Date: Aug. 29, 2024

(54) Method for producing sound insulation

(71) Applicant: Adler Pelzer Holding GmbH, Hagen (DE)

(72) Inventors: Volkmar SCHULZE, Schierling (DE); Klaus KRÖMER, Rhauderfehn (DE); Matthias DICKERT, Witten (DE)

(21) Appl. No.: 18/585,884

(22) Filed: Feb. 23, 2024

(30) Foreign Application Priority Data
Feb. 23, 2023 (DE) 10 2023 104 422.2

(51) Int. Cl. B32B 37/10; B32B 5/02; B32B 7/12; B32B 37/08

(52) U.S. Cl. CPC B32B 37/1009; B32B 5/022; B32B 7/12; B32B 37/08; B32B 2307/102; B32B 2309/02; B32B 2310/049

(57) ABSTRACT

A method for producing a sound insulation for a motor vehicle includes the steps: Positioning a nonwoven layer and a wear layer into steam/vacuum tool such that a flow-closed side faces the nonwoven layer, wherein the nonwoven layer has a binding element and in particular a binding fiber; Close the steam/vacuum tool and apply a vacuum to the upper tool and/or lower tool; Applying steam or hot air to the underside of the nonwoven layer; and Reduction of the steam or hot air pressure through a lower pressure on the wear layer side compared to the pressure on the underside of the nonwoven layer.

### BACKGROUND OF THE INVENTION

The subject of the invention is a method and, in particular, a one-step method for the production of sound insulation, in particular floor linings and luggage compartment linings for a motor vehicle, comprising a wear layer-consisting of the surface/visible surface layer with possibly further layers underneath—and a non-woven layer, in particular an airlay non-woven layer, the mechanical-physical and acoustic properties of which preferably differ (partially) across the surface zone by zone.

The floor linings and luggage compartment linings used in motor vehicles today generally have material structures that comprise a wear layer-consisting of the surface/visible surface layer with adhesive layers underneath, acoustic/stiffening fleeces, sealing and heavy foils as well as contact/foil fleeces—and the insulation, arranged between the wear layer and the body floor.

In practice, various designs of floor lining and luggage compartment lining wear layers are known; tufted, velour (dilours) and flat needlefelt carpets are widely used here as the surface/visible surface layer.

In particular in VANs, SUVs, pickups and light commercial vehicles also rubber, PUR-RIM, PVC and increasingly TPO (surface-structured/with grain) are used in the state of the art as the surface/visible layer of the wear layer.

DE 10 2018 114 125 A1 sets out a manufacturing process with associated apparatus for the production of molded textile multilayer composites, which in particular guarantees a reduction in material requirements and cycle times; in addition, the heat required for laminating and shaping is to be introduced even with short cycle times.

DE 10 2012 222 000 A1 discloses a method for the production of at least two-layer components as absorbent linings in the interior and/or luggage compartment or for floor linings of motor vehicles, comprising an upper product and a carrier, characterized in that
(a) a carrier material formed in a flock box on one side and containing filler and binder is introduced into a steam/vacuum tool,
(b) the upper product cut to the shape of a blank is inserted into the tool with its flow-closed side facing the carrier material,
(c) the tool closes,
(d) forming the upper product by applying vacuum to its visible side while solidifying the carrier material by applying first vacuum and then steam/vacuum from its underside, thereby forming the component into final contour and bonding the upper product and carrier material together, and
(e) then cool the component in a calibration tool or storage tray.

DE 10 2021 101 921 A1 and DE 10 2021 101 922 A1 describe methods for the production of floor lining insulation or a sound-insulating lining and, in particular, floor linings for a motor vehicle, which have an insulation comprising fibers and/or an insulation consisting of or comprising flocked fiber layers.

The methods described here are therefore relatively complex and require several process steps, and are also very energy-intensive.

Based on the aforementioned state of the art, the object therefore arises of simplifying the known methods.

### SUMMARY OF THE INVENTION

In a method according to the invention for producing a sound insulation, in particular floor linings and luggage compartment linings for a motor vehicle, wherein the sound insulation has a wear layer with a surface and/or visible surface layer with optionally further layers located thereunder as well as a non-woven layer, and in particular an airlay non-woven layer, the mechanical-physical and acoustic properties of which differ over the surface (of the sound insulation and/or of the (non-woven layer)) in zones and/or areas and/or partially, the following (partial) steps are carried out:
positioning a nonwoven layer as a blank in a tool, in particular a steam/vacuum tool;
insertion of a wear layer into the steam/vacuum tool in such a way that a flow-closed side (of this wear layer) faces the nonwoven layer, wherein the nonwoven layer has a binding element and in particular a binding fiber;
closing the steam/vacuum tool;

Preferably, the above-mentioned (partial) steps are carried out in the above-mentioned sequence.

It should be noted that the sound insulation is preferably a sound insulation device, so that these two terms are used synonymously in the context of the present application.

The nonwoven layer is in particular an airlay nonwoven layer. An airlay nonwoven layer is a nonwoven layer that has been produced using an airlay method. In an airlay method, the fiber material is transferred into an existing or specially generated air flow after the opening process. This can, for example, be carried out by the last opening roller.

Airlay methods are capable of processing fibers of synthetic and natural origin (in particular with typical fiber lengths in the range between 20 mm and 120 mm) into nonwovens, in particular nonwovens with a mass per unit area between 100 g/m² and 5000 g/m².

The airlay method belongs to the group of aerodynamic web formation processes in which the web is formed using air. Due to technical/technological process characteristics, the fiber arrangement (uniformity of fiber distribution and mass per unit area) can be qualitatively influenced in the random layer, and due to the single layer there is no pile splitting.

A wide range of (synthetic and natural) fibers can also be processed, in particular with regard to fiber length and fiber fineness. As mentioned above, the mass per unit area of the nonwovens is in the range between 100 g/m² and 5000 g/m².

The airlay method therefore offers good conditions for the use of recycled fibers (with good crimp). In addition, the airlay method makes it easy to incorporate filling materials such as fiber balls and fiber loops of various geometries and fiber types.

In addition, the airlaid technologies currently on the market can be used to influence the nonwoven properties as required.

Due to the investment volume and operating costs for the production facilities, the airlay method is also a very economical and energy-efficient method.

For a more detailed description of the airlay method, reference is made to the textbook Vliesstoffe, Rohstoffe, Herstellung, Anwendung, Prüfung, Zweite, vollständig überarbeitete Auflage, 2012 Wiley-VCH Verlag & Co./KGaA (Print ISBN 978-3 527 64 589-2). The disclosure of this document, in particular the disclosure under chapter 4.1.3.1 (The Airlay method) is also made to the subject of the present disclosure in its entirety.

In a preferred method, vacuum is applied to the upper tool and/or lower tool and in particular to both the upper tool and the lower tool. This makes it easier to contour the wear layer in particular.

In a further preferred method, steam or hot air is applied to an underside of the nonwoven layer, which is in particular an airlay nonwoven layer, whereby the wear layer is deformed, the binding fiber in the nonwoven layer is activated and the wear layer and the nonwoven layer are bonded together.

Preferably, the steam or hot air pressure is reduced, in particular by a lower pressure on the wear layer side compared to the pressure on the underside of the nonwoven layer.

Preferably, the layer composite is subsequently demolded and cooled in the calibration tool or a storage tray.

In a further advantageous method, after the steam or hot air pressure in the lower tool has been reduced, vacuum is drawn again briefly, in particular before the tool opening; this causes the (airlay) layer to be cooled in the steam/vacuum tool.

A short time is understood to be a period of between one second and seven seconds, preferably between 2 seconds and 4 seconds.

The underside of the nonwoven layer, in particular the airlay nonwoven layer, is the side (and/or surface) facing away from the wear layer.

In particular, a manufacturing method in only one (single) step is proposed, namely the application of steam or hot air to the (airlay) nonwoven layer, forming and laminating as well as vacuum impacting.

In this single step (one process step in exactly one tool), the wear layer and the (airlay) nonwoven layer are deformed and the wear layer is bonded to the (airlay) nonwoven layer. In the state of the art, several steps had to be carried out at this point using a plurality of systems and apparatus.

Preferably, therefore, the application of steam/vacuum and/or hot air is the only process step that determines the production of the sound insulation, in which the (airlay) nonwoven layer and the wear layer are applied with steam/vacuum and/or hot air; in which the sound insulation is given its shape/contour and retains this in a stable process.

The deformation is therefore preferably caused by the described pressure differences and the bonding by the temperature of the hot air or steam. For both effects, it is important that the flow-closed side of the wear layer faces the (airlay) nonwoven layer, as this results in both a pressure and a temperature build-up.

A steam/vacuum tool is understood in particular to be a tool into which an object to be treated can be inserted and preferably applied with vacuum and/or steam. This steam/vacuum tool preferably has an upper tool and a lower tool, wherein the object to be treated can be inserted between this upper tool and the lower tool and these two tools can then be closed.

The steam/vacuum tool is preferably provided with nozzles in the upper tool through which the vacuum can be applied; and the nozzles for steam/vacuum or hot air/vacuum are positioned in the lower tool. The tool gap corresponds (essentially) to the total thickness of the sound insulation. An example of such a steam/vacuum tool is known from DE 103 35 721 A1.

Preferably, the mechanical-physical and/or acoustic properties that differ across the surface (of the sound insulation and/or the war layer as well as the (airlay) nonwoven layer) zone by zone and/or area by area and/or partially are selected from a group of properties that result from the overall structure; in particular, the fiber mixture and fiber structure, the layer thicknesses and layer densities as well as the flow permeability are to be seen here.

No methods and apparatus are known from the state of the art that describe the production of sound insulation consisting of a wear layer and an (airlay) nonwoven layer in a one-step method using steam/vacuum or hot air technology.

In addition, the methods described in the state of the art are very complex in their process engineering, in particular with regard to fiber preparation, flaking and semi-product transport. This is reflected in long cycle times, high energy requirements and the amount of space needed for the plant. The high maintenance and servicing costs must also be taken into account here.

This proposes the provision of a one-step method for producing a sound insulation, in particular a floor lining or luggage compartment lining for a motor vehicle with non-woven insulation, wherein in particular the wear layer and the non-woven insulation are formed into a sound insulation in a (single) step; wherein in particular the insulation comprises an (airlay) non-woven and this preferably has different mechanical-physical and acoustic properties over the surface and thickness.

In a preferred embodiment, the wear layer comprises a carpet, in particular a tufted carpet, a velour (dilour) carpet or a flat needlefelt carpet.

For tufted carpets, PA6.6, PA6, PP, rPA and PET, rPET and PBT as well as bio-based polyamides (PA 5.10; PA 6.10) or wool are the preferred yarn/filament materials.

PET, PET/PP, PP, PA/PET and/or rPET are the preferred fiber materials for velour and flat needlefelt carpets.

The tufting carrier for the tufting qualities preferably consists of PET/PP, PET/coPET or PET/PA as well as PET/PA+PP. The preferred tufting carriers in tufted carpets for the automotive industry are spunbond nonwoven (100% polyester) and nonwoven based on thermally bonded continuous bicomponent filaments [core-sheath fibers, PET core and PP sheath]; preferably in a grammage range of 80 to 140 g/m².

The filament/yarn (yarn nap) or fiber bindings used here comprise mainly EVA and PE preferably in tufted carpets and SBR latex or acrylate for velour and flat needlefelt carpets. Furthermore, films, nonwovens, adhesives (hot melts) and thermoplastics (mainly PE) are preferably used for velour and flat needlefelt carpets. Furthermore, binding fibers, EVA or thermoplastic dispersions are increasingly being used.

The coatings, mostly as an adhesive layer for underlays, but also for reinforcement, preferably comprise PE or PP.

Adhesives (hot melts), thermoplastic dispersions and PE and EVA/PE powders are preferred in order to ensure bonding and coating in one.

Preferably, the composite has at least one further layer or sub-layer.

Preferably, such sub-layers, such as acoustic and/or stiffening nonwovens, consist of PET and/or mixed fiber nonwovens, often with a predetermined BiCo fiber content.

In a further method, multi-layer and in particular three-layer recycled sandwich nonwovens are used to produce the sound insulation.

Preferably, the composite to be produced and/or the sound insulation has sealing and/or insulating films. PE/PA and PE/PA/PE films and non-woven PE/PA/PE+PET films are preferred as sealing or insulating films. In addition, so-called heavy films based on EVA, PE, PP and EPDM can also be used partially and/or over the entire surface as insulating films.

Between the wear layer (often generally also referred to as the upper product) and the car body floor there is advantageously an insulating layer, which can be formed in particular from PUR foam or nonwoven structures (nonwovens or fiber-flock (HMP) composites). If a foam is used, it is preferably firmly bonded to the wear layer (and in particular foamed on). Nonwoven/fiber-flock structures can also be firmly bonded to the wear layer, wherein these are then usually glued or fused. However, pure overlaying without a fixed connection is also used.

With acoustically open, highly absorbent floor covering systems in particular, the focus is on the acoustic and/or reinforcement fleeces, which are bonded (laminated) to the carpet (wear layer) in a way that is open to the flow.

These are preferably polyethylene terephthalate (PET) or mixed fiber nonwovens-often with a percentage of BiCo fibers—and preferably in a grammage range of 250 to 1800 g/m². Recycled sandwich nonwovens are also increasingly being used here.

The properties of the foam insulations differ significantly in the specifications of the car manufacturers in terms of density, modulus of elasticity and loss factor; the nonwovens or fiber-flock (HMP) composites of an insulation differ in density and compression hardness.

Such floor lining systems are described, for example, in DE 10 2004 046 201 A1, DE 103 60 427 A1, DE 199 60 945 A1 and DE 10 2007 036 952 A1.

The following floor lining insulations are essentially known in the state of the art:
a.) Viscoelastic foam, DE 39 05 607 A1, WO 2006/032433 A1
b.) Lightweight foam (cut foam), DE 10 2008 017 893 A1 (partial)
c.) Foam with partially varying density, EP 0 210 102 B1, EP 0 169 627 A2
d.) Non-woven (glued/laminated non-woven die-cut parts)
e.) Preformed (bonded) nonwovens
f.) Fiber flock insulation (HMP), DE 10 2008 013 808 A1, DE 103 24 735 B3
g.) Nonwovens with upright/vertical fiber orientation, US 2017/0008462 A1, U.S. Pat. No. 9,321,412 B2, DE 10 2020 116 315 A1, WO 2021/254565 A1
h.) Fiber flock insulation (HMP) with upright/vertical fiber orientation, DE 10 2012 003 093 A1, DE 10 2010 034 159 A1
i.) Pressed fiber material consisting of fiber balls, DE 20 2020 101 433 U1, DE 10 2021 101 905 A1
j.) Combination of fiber-flock layers with further fiber-flock layers or nonwoven or foam layers, DE 10 2021 101 921 A1, DE 10 2021 101 922 A1

It is known that so-called crash elements, floor mat fastening elements and footrest elements are integrated into the insulation. EPS, EPP and PEPP inserts are also primarily placed in the insulation to increase the impact resistance, among other things.

DE 10 2009 058 819 A1 describes a structure with spacers for this purpose. Furthermore, it is known to foam-in composite foam pieces (DE 36 23 789 A1). DE 20 2008 004 918 U1 states that anti-drumming films are (partially) applied to the carpet composite at several points in a force-fit or material-fit manner.

In a preferred method, the wear layer is or is cut to size and, in particular, cut in the shape of a blank.

Preferably, the wear layer and/or airlay nonwoven layer extends in a longitudinal direction, a width direction perpendicular thereto and a thickness direction perpendicular to the longitudinal direction and the width direction. Preferably, the area in which the mechanical-physical and/or acoustic properties (of the airlay nonwoven layer) change or differ extends in the longitudinal direction and the width direction.

Preferably, the nonwoven insulation or the (airlay) nonwoven is positioned as a blank in the steam/vacuum tool without being tempered (i.e. in particular at room temperature). Preferably, the blank-shaped and tempered wear layer is placed in the steam/vacuum tool with its flow-closed side facing the (airlay) layer or the (airlay) nonwoven layer containing a binding fiber.

As described above, the steam/vacuum tool is then closed; the contour of the layers is already shaped by applying vacuum in the upper and lower tool, the wear layer is finally shaped by applying steam or hot air from the underside of the (airlay) nonwoven layer; the binding fiber is activated in the (airlay) nonwoven layer and the wear layer and the (airlay) nonwoven layer are bonded together. The steam or hot air pressure is then released, in particular by reducing the pressure on the wear layer side compared to the pressure on the underside of the (airlay) nonwoven layer. Subsequently, after demolding the layer composite from the steam/vacuum tool, the layer composite is cooled in a calibration tool or a storage tray and then die-cut or cut using a water jet.

The method described in DE 10 2008 013 808 A1 allows, in particular through the use of baffle plates and special throttle flaps, a demand-oriented distribution of the fiber/flake mixture over the surface of the insulation to be produced.

So-called thermoforming systems are used for the production of floor linings in automotive engineering, the forming of the wear layer, in which the individual layers of the wear layer are available as blanks or rolls. These can be operated fully automatically, semi-automatically or in a manual process.

In the state of the art, thermoforming systems with the following apparatus are known, which are usually arranged one behind the other in a throughput direction:
goods storage>storage table>contact heating panel>contact heating panel>radiant heating panel>forming tool
goods storage>storage table>contact heating panel>radiant heating panel>forming tool
goods storage>storage table>contact heating panel>contact heating panel>forming tool
goods storage>storage table>contact heating panel>forming tool
goods storage>storage table>radiant heating panel>forming tool

The transport of the laid overall composite (the wear layer) is preferably carried out using transport and gripper systems. It is also common to use pick-and-place to place partial individual layers on the storage table.

Preferably, airlay nonwovens are used that have virgin or recycled PET fibers and BiCo fibers (coPET/PET) in their fiber composition on the one hand, and virgin or recycled PET fibers and BiCo fibers (coPET/PET) and cotton in varying percentages on the other. It is advantageous here if the PET fibers have a high crimp.

Preferably, the (airlay) nonwoven layer is or has a single or multi-layer (airlay) nonwoven, and the sound insulation has a density distribution (mass per unit area distribution, or a changing density) over the length and/or width.

Preferably, larger thickness and/or contour jumps in the sound insulation are compensated for before the wear layer is inserted into the steam/vacuum tool. As mentioned above, this is done in particular by partially adding fibers and/or (airlay) pads. Larger jumps in thickness and/or contour are understood to mean thicknesses that are greater than the initial thickness of the (airlay) nonwoven layer. In addition, partial thickening is used to increase the rigidity of the sound insulation or to create areas in which fastening elements can be installed, such as clips for attaching floor mats or similar.

The advantage here too is that any (airlay) nonwoven pads required do not need any additional production steps; they are taken from the existing nonwoven blanks.

Crash pads, e.g. made of EPP, PEPP or EPS, can also be inserted in this method.

The pads can be positioned in 2D blank form or in 3D preformed form; in addition to the thickness/contour compensation, these preferably also serve to improve the insulation and thus component rigidity. It would also be possible to arrange several pads on top of each other.

In a further preferred method, the airlay nonwoven layer has a base nonwoven, preferably with nonwoven pads distributed partially over the surface in a predetermined manner.

In a further preferred method, the steam applied to the underside of the airlay nonwoven layer in the steam/vacuum tool has a pressure greater than 1.5 bar, preferably greater than 2.0 bar.

In a further preferred method, the steam applied to the underside of the airlay nonwoven layer in the steam/vacuum tool has a pressure that is less than 8 bar, preferably less than 6 bar and particularly preferably less than 5 bar.

In a further preferred method, the steam applied to the underside of the airlay nonwoven layer in the steam/vacuum tool has a temperature greater than 100° C., preferably greater than 110° C.

In a further preferred method, the steam applied to the underside of the airlay nonwoven layer in the steam/vacuum tool has a temperature that is less than 200° C., preferably less than 180° C., preferably less than 160° C.

In a further preferred method, the wear layer is inserted into the steam/vacuum tool in a non-tempered state (i.e. in particular at ambient temperature), provided that the component is largely flat and has few contours.

In a further preferred method, the (airlay) nonwoven layer is inserted into the steam/vacuum tool without being tempered, in particular the (airlay) nonwoven layer is thus inserted into the steam/vacuum tool at room temperature.

In a further preferred method, the wear layer is inserted into the steam/vacuum tool at a controlled temperature.

Particularly preferably, the wear layer is inserted into the steam/vacuum tool at a temperature that is greater than 80° C., preferably greater than 100° C.

Particularly preferably, the wear layer is inserted into the steam/vacuum tool at a temperature of less than 200° C., preferably less than 180° C.

Preferably, the wear layer is heated before being placed in the steam/vacuum tool. This can be done in particular by means of a radiant heating field.

The temperature is preferably applied to the reverse side of the wear layer, the side facing away from the top/visible side. A plurality of studies have shown that it is advantageous if a temperature of 110° C. to 150° C. prevails inside the layer composite (wear layer and sub-layers).

In a further preferred method, the wear layer has a film which causes one side of the wear layer (which extends in particular in the longitudinal direction and the width direction) to be flow-closed (vapor-tight), wherein the film is preferably a multi-layer film.

The flow-sealed side of the wear layer is preferably realized by using a film, in particular a PE/PA/PE film, in particular a PE/PA/PE+EVA film. This steam-tight film should preferably be seen as a process film, as this is what enables the contour to be formed in the steam/vacuum tool in the first place.

A plurality of studies have shown that it is advantageous if the PA layer is greater than or equal to 23 μm.

In the case of wear layers coated with a PE extrusion layer of more than 300 g/m², the film can be omitted if necessary.

Preferably, in a further method step, the compound of the wear layer and the (airlay) nonwoven layer is cooled, which is preferably done in a calibration tool or a storage tray.

In a further preferred method, the compound of the wear layer and the (airlay) nonwoven layer is die-cut and/or cut in a further method step. This can preferably be done using a water jet.

In a further preferred method, the wear layer is stretched before molding.

Preferably, the wear layer is stretched in its longitudinal direction. Preferably, the wear layer is also stretched in the width direction. Particularly preferably, the wear layer is stretched to a different extent in the longitudinal direction and in the width direction.

Particularly preferably, the wear layer is stretched to varying degrees in the transverse direction over the course of a longitudinal side.

In a further preferred method, the wear layer is stretched to varying degrees in the longitudinal direction over the course of a transverse side.

In a further preferred method, the wear layer has at least one further and preferably several further layers located below the surface and/or visible surface layer.

Particularly preferably, this further layer and preferably these further layers are selected from a group of layers which includes adhesive layers, acoustic layers and in particular acoustic nonwovens, stiffening layers and in particular stiffening nonwovens, sealing films, heavy films, contact nonwovens and/or film nonwovens.

In a further advantageous embodiment of the method for producing a sound insulation, in particular a floor lining for a motor vehicle, in particular with a small installation space for the sound insulation or floor lining itself, and in particular for the (airlay) nonwoven layer, but accompanied by small contour jumps, the initial thickness of the (airlay) nonwoven used essentially corresponds to the insulation installation space of the component, in particular the sound insulation. Preferably, no additional pads or the like are used in this case to compensate for the thickness.

Such contours (surface shapes/designs) are preferably found in electric vehicles, where the contour of the body floor is less pronounced compared to vehicles with combustion engines.

This means that the total thickness of the nonwoven insulation can be covered by the airlay nonwoven layer used.

If the body floor has larger contour jumps or if the overall thickness of the sound insulation is greater, multi-layer-full-surface or partial multi-layer-airlay nonwovens can also be used. This can also be used to achieve a density distribution and/or mass per unit area distribution over the length and width.

The core of the present invention is thus the provision of a method for the production of sound insulation with (airlay) non-woven insulation for a motor vehicle, which makes it possible to produce a wear layer with possibly sub-layers with a single or multi-layer airlay non-woven insulation layer, which can have a defined density distribution over length and width, in a (single) step.

Preferably, the method is carried out in only one step and/or in exactly one tool. The above-mentioned steps of the method preferably represent partial steps of the method in this context, which are, however, preferably carried out in exactly one tool.

An advantage of this method is that the density distribution of the airlay nonwoven insulation not only significantly shortens the cycle time in the manufacturing process, but also reduces the weight of individual process stages.

In addition, the recyclability and the use of recycled material should also be mentioned here.

In a preferred method, as mentioned above, the wear layer is stretched before forming and, in particular, stretched to varying degrees in the transverse direction over the course of a longitudinal side and/or to varying degrees in the longitudinal direction over the course of a transverse side. Preferably, stretching takes place in several directions and, in particular, stretching takes place to varying degrees in several directions.

It should be noted here that the temperature exposure of the wear layer in particular is limited by the fiber/yarn material and that the sub-layers must not be destroyed by the applied temperature. On the other hand, the wear layer itself should be exposed to temperatures that allow good expanding/stretching (without individual layers melting or tearing, for example). With regard to time/temperature control, it should also be noted that the final component must meet the requirements of the automotive industry. In particular, the climate change test (shrinkage) and the wear behavior should be mentioned here.

The present invention is further directed to a sound insulation, in particular for a floor covering with an (airlay) non-woven layer for a vehicle, wherein the airlay non-woven layer and/or the sound insulation has different acoustic and/or mechanical-physical properties over the area and/or thickness, in particular of the (airlay) non-woven layer, and wherein the sound insulation has at least one wear layer with a surface layer, preferably with sub-layers located under this surface layer, and the (airlay) non-woven layer. In particular, this sound insulation is produced using a method of the type described above.

In a preferred embodiment, the (airlay) nonwoven layer has a binding element, in particular an activated binding element and in particular an activated binding fiber. Preferably, this binding element is activated by heating.

In a preferred embodiment, the airlay nonwoven layer is bonded to the wear layer and, in particular, bonded by the activated binding fiber.

In a further preferred embodiment, the wear layer has a flow-closed side and/or surface. Particularly preferably, this flow-closed side extends in a longitudinal direction and a width direction of the wear layer.

In a further preferred embodiment, this flow-closed side and/or surface is in contact with the (airlay) nonwoven layer. Particularly preferably, this flow-closed side is connected to the (airlay) nonwoven layer and in particular connected by means of the activated binding element.

Preferably, the sound insulation device is manufactured using a method of the type described above.

In a further advantageous method, an (airlay) nonwoven layer in the form of an (airlay) nonwoven blank is used.

Preferably, this (airlay) nonwoven blank has a weight per unit area of more than 200 g/m², preferably more than 400 g/m², particularly preferably more than 600 g/m².

Preferably, this (airlay) nonwoven blank has a weight per unit area of less than 2000 g/m², preferably less than 1800 g/m².

Preferably, the airlay nonwoven blank (layer) comprises fiber blends consisting of BiCo fibers, PET fibers, PBT fibers, recycled fibers, and cotton.

In addition to the usual full cross-section fibers, hollow fibers are also often used.

Preferably, the airlay nonwoven blank has a mass proportion of BiCo fibers that is greater than 5%, preferably greater than 10%.

Preferably, the airlay nonwoven blank has a mass proportion of BiCo fibers that is less than 50%, preferably less than 45%.

### BRIEF DESCRIPTION OF THE DRAWINGS

Further advantages and embodiments are shown in the attached drawings. In the drawings: show:

FIG. 1 shows the wear layer of a floor lining for a motor vehicle, produced according to the method of the invention; and

FIG. 2 shows the underside of a floor lining for a motor vehicle, the side of the airlay nonwoven layer facing the body floor, produced by the method according to the invention;

FIG. 3 shows a schematic representation of a floor lining structure with associated cross-sectional photo.

### DETAILED DESCRIPTION OF THE INVENTION

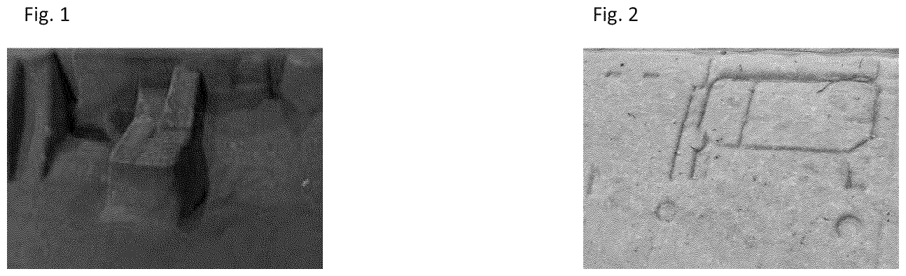

To produce the floor lining shown in FIGS. 1-3, an airlay nonwoven blank (with a weight per unit area of 1000 g/m² and the fiber composition of 80% PET 28 dtex/38 mm length and 20% BiCo 4 dtex/32 mm length) was positioned on the underside of the steam/vacuum tool. At the same time, a 400 g/m² 100% PET-fiber dilour carpet (wear layer) with a fiber bonding of 50 g/m² acrylate and a 128 g/m² PE/PA/PE film was heated in the radiant heating field to about 135° C. in the composite.

The heated wear layer with the PE/PA/PE film sub-layer was then placed over the airlay nonwoven blank in the steam/vacuum tool using a gripper transfer system and the steam/vacuum tool was closed. Steam is then applied (120-140° C., 15 sec, differential pressure of 3 bar). After 33 seconds, the steam/vacuum tool was opened and the wear and airlay fleece layer formed into the floor lining was placed in the cooling/calibration tool and calibrated. The die-cutting was then carried out.

Tests with airlay nonwoven layers with different fiber blends and weights per unit area have confirmed that the mechanical-physical properties of floor and luggage compartment linings required by OEMs can be adjusted.

FIG. 1 shows a section of the floor lining; the good shaping of the contour, in particular the radius mobility and the dimensional stability are clearly visible.

FIG. 2 shows the contour of the airlay fleece layer of the floor lining, which is positioned towards the body sheet metal in the vehicle when installed.

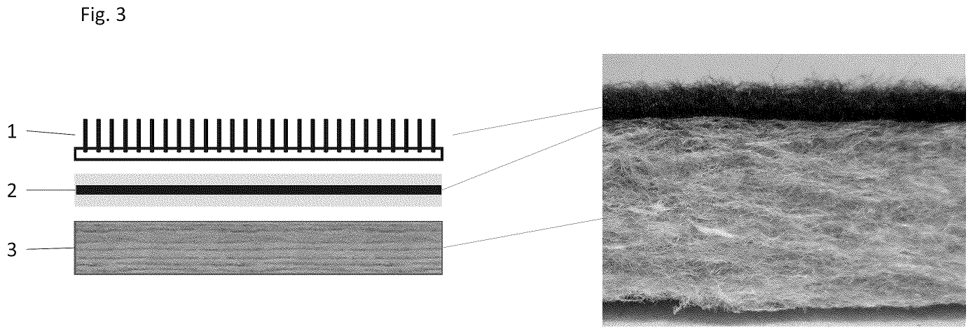

FIG. 3 schematically shows the structural composition of a floor lining, consisting of a wear layer (1), foil (2) and airlay fleece layer (3).

At the same time, the fiber layer in the airlay fleece (3) is clearly visible in the associated cross-sectional photograph.

The applicant reserves the right to claim all features disclosed in the application documents as being essential to the invention, provided that they are new, either individually or in combination, compared to the state of the art. It should also be noted that the individual figures also describe features which may be advantageous in themselves. The person skilled in the art immediately recognizes that a certain feature described in a figure can also be advantageous without the adoption of further features from this figure. Furthermore, the person skilled in the art recognizes that advantages can also result from a combination of several features shown in individual figures or in different figures.

### LIST OF REFERENCE SYMBOLS

1 wear layer
2 film
3 airlay fleece layer

1. A method for producing a sound insulation, in particular for floor linings and luggage compartment linings for a motor vehicle, wherein the sound insulation has a wear layer with a surface and/or visible surface layer and a non-woven layer, the mechanical-physical and acoustic properties of which differ over the surface of the sound insulation, preferably zonally and/or partially, comprising the steps of:
Positioning the nonwoven layer as a blank in a steam/vacuum tool;
Insertion of a wear layer into the steam/vacuum tool in such a way that a flow-closed side faces the nonwoven layer, wherein the nonwoven layer has a binding element and in particular a binding fiber;
Close the steam/vacuum tool;
Applying a vacuum to the upper tool and/or lower tool, which makes it easier to contour the wear layer;
Applying steam or hot air to the underside of the nonwoven layer, which deforms the wear layer, activates the binding fiber in the nonwoven layer and bonds the wear layer and the nonwoven layer together;
Reduction of the steam or hot air pressure, in particular through a lower pressure on the wear layer side compared to the pressure on the underside of the nonwoven layer;
Preferably demolding of the layer composite from the steam/vacuum tool and cooling in the calibration tool or a storage tray.

2. The method for producing a sound insulation according to claim 1,
wherein
the nonwoven layer is an airlay nonwoven layer.

3. The method for producing a sound insulation according to claim 1,
wherein
after reducing the steam or hot air pressure in the lower tool, vacuum is drawn again briefly before the tool opening.

4. The method for producing a sound insulation according to claim 1,
wherein
the method is carried out in one step and/or in exactly one tool, in particular exactly one steam/vacuum tool.

5. The method for producing a sound insulation according to claim 1,
wherein
before inserting the wear layer into the steam/vacuum tool, larger thickness and/or contour jumps in the sound insulation are compensated for by partially adding elements and in particular fibers or pads, in particular airlay pads.

6. The method for producing a sound insulation according to claim 1,
wherein
the nonwoven comprises a base nonwoven with nonwoven pads partially distributed over the surface in a predetermined manner.

7. The method for producing a sound insulation according to claim 1,
wherein
the wear layer is inserted into the steam/vacuum tool in a non-tempered state and, in particular, the wear layer is inserted into the steam/vacuum tool in a non-tempered state to produce largely flat and/or less contoured sound insulation.

8. The method for producing a sound insulation according to claim 1,
wherein
the non-woven layer is inserted into the steam/vacuum tool in a non-tempered state.

9. The method for producing a sound insulation according to claim 1,
wherein
the wear layer is placed in the steam/vacuum tool at a tempered state and preferably at a temperature in the layer composite in the steam/vacuum tool which—in particular depending on the material structure—is greater than 80° C., greater than 100° C., greater than 120° C. and selected from the group consisting of greater than 130° C. and/or is placed in the vacuum/steam tool at a temperature selected from the group consisting lower than 200° C., lower than 180° C., lower than 160° C. and lower than 150° C.

10. The method for producing a sound insulation according to claim 1,
wherein
the wear layer comprises a film which causes one side of the wear layer to be flow-closed,
wherein the film is preferably a multilayer film.

11. The method for producing a sound insulation according to claim 1,
wherein
in a further method step, the compound of the wear layer and the nonwoven layer, which is in particular an airlay nonwoven layer, is cooled, which is preferably carried out in a calibration tool or a storage tray.

12. The method for producing a sound insulation according to claim 1,
wherein,
in a further method step, the connection of the wear layer and the nonwoven layer, which is in particular an airlay nonwoven layer, is die-cut and/or cut.

13. The method for producing a sound insulation according to claim 1,
wherein
the wear layer is stretched before forming and, in particular, is stretched over the course of a longitudinal side to varying degrees in the transverse direction and/or over the course of a transverse side to varying degrees in the longitudinal direction.

14. The method for producing a sound insulation according to claim 1,
wherein
the wear layer has at least one further and preferably further layers located underneath the surface and/or visible surface layer, wherein these further layers are preferably selected from a group of layers which includes adhesive layers, acoustic layers and in particular acoustic nonwovens, stiffening layers and in particular stiffening nonwovens, sealing films, heavy films, contact nonwovens and film nonwovens.

15. A sound insulation produced by a method according to claim 1,
wherein
the wear layer has a flow-closed side and/or surface layer and this flow-closed side and/or surface layer lies against and/or is connected to the nonwoven layer, which is in particular an airlay nonwoven layer.
